(19) United States
(12) Patent Application Publication
(10) Pub. No.: US 2005/0005093 A1
(43) Pub. Date: Jan. 6, 2005

(54) Methods, systems and devices for securing supervisory control and data acquisition (SCADA) communications

(76) Inventors: Andrew Bartels, Mesa, AZ (US); Mike Guillotte, College Station, TX (US); Peter Schneider, Calgary (CA)

Correspondence Address: INGRASSIA FISHER & LORENZ, P.C., 7150 E. CAMELBACK, STE. 325, SCOTTSDALE, AZ, 85251, US

(21) Appl. No.: 10/869,217

(22) Filed: Jun. 15, 2004

Related U.S. Application Data
(60) Provisional application No. 60/484,383, filed on Jul. 1, 2003.

(51) Int. Cl. H04L 9/00

(52) U.S. Cl. 713/150

(57) ABSTRACT

A secure supervisory control and data acquisition (SCADA) system includes a SCADA control host system and any number of remote terminal unit (RTU) systems. Each RTU system includes an RTU transceiver, an RTU and a remote security device (RSD) coupling the RTU to the RTU transceiver. The SCADA control host system includes a SCADA control host configured to exchange SCADA information with each of the RTUs in a SCADA format, and a host security device (HSD) coupling the SCADA control host to a host transceiver. The host transceiver is configured to establish communications with each of the plurality of RTU transceivers. The HSD communicates with the RSDs to transparently encrypt the SCADA information using a cryptographic protocol that is independent of the SCADA protocol to thereby secure the communications between the HSD and each of the RSDs.

### PRIORITY DATA

This application claims the benefit of U.S. Provisional Application Ser. No. 60/484,383 filed Jul. 1, 2003 and incorporated herein by reference.

### TECHNICAL FIELD

The present invention generally relates to supervisory control and data acquisition (SCADA) systems, and more particularly relates to systems, techniques and devices for securing communications within a SCADA environment.

### BACKGROUND

Supervisory control and data acquisition (SCADA) systems are computer-based systems used for gathering data and/or for controlling industrial systems in real time. SCADA systems are frequently used to monitor and control industrial equipment and processes in such industries as telecommunications, manufacturing, water and waste control, energy generation and distribution, oil and gas refining, transportation and the like. At present, approximately 350,000 SCADA systems are installed in the United States, with many of these systems being used to monitor and control such important infrastructure components as the power grid, water and sewer systems, factories, dams and many others.

A conventional SCADA system includes a central monitoring station (CMS) or other host that communicates with multiple remote stations via a communications network. Each remote station is typically affiliated with a sensor, controller or other field instrumentation for gathering data or affecting some aspect of the controlled system. Examples of conventional sensors include sensors for monitoring the temperature, pressure or flow rate of a gas or fluid, for example, whereas exemplary control instrumentation includes switches, valves, actuators and the like. Data observed from the various sensors is provided to the host, which typically processes the data and responds to user inputs to create control signals that can be used to alter the controlled system via control instrumentation.

More recently, concerns have arisen as to the security of SCADA communications. Because SCADA is used in many highly-sensitive environments, it is feared that SCADA systems could be exploited by terrorists or other unscrupulous individuals to create chaos, industrial accidents or other maladies. SCADA systems were not typically designed to be highly secure, meaning that such systems may be susceptible to tampering, overloading, hostile control or the like. Examples of attacks that could conceivably be mounted on SCADA implementations include overwhelming the relatively low-power transmitters used in such systems with higher power signals, mounting “replay attacks” wherein previously-sent data packets are digitally recorded and re-sent at an inappropriate time, or gaining control of some or all of a SCADA system by reverse engineering SCADA protocols, many of which are available to the public for little or no cost.

Accordingly, it is desirable to create systems, devices and techniques for securing SCADA communications, particularly SCADA systems used to monitor and control infrastructure elements. In addition, it is desirable to formulate secure systems, devices and techniques in a manner that allows for convenient adoption in existing SCADA environments. Other desirable features and characteristics will become apparent from the subsequent detailed description and the appended claims, taken in conjunction with the accompanying drawings and this background material.

### BRIEF SUMMARY

Systems, methods, devices and data structures are provided for securing networked, wireless, hardwired or other communications in a SCADA environment. According to various exemplary embodiments, a SCADA control host system securely communicates with any number of remote terminal unit (RTU) systems. Each RTU system includes an RTU transceiver, an RTU and a remote security device (RSD) coupling the RTU to the RTU transceiver. The SCADA control host system includes a SCADA control host configured to exchange SCADA information with each of the RTUs in a SCADA format, and a host security device (HSD) coupling the SCADA control host to a host transceiver, which suitably establishes communications with each of the RTU transceivers. The HSD communicates with the RSDs to transparently encrypt the SCADA information using a cryptographic protocol that is independent of the SCADA protocol to thereby secure the communications between the HSD and each of the RSDs.

In other embodiments, a security device is provided between a SCADA component and a transceiver securing communications between the SCADA component and another security device. The SCADA component may be a SCADA control host, a remote terminal unit or any other device. In such embodiments the security device includes a clear interface to the SCADA component, a secure interface to a transmitter/receiver, and a processor configured to encrypt the clear data received at the clear interface to thereby create encrypted data for transmission via the secure interface. The security device conversely decrypts encrypted data received at the secure interface to thereby extract clear data for transmission via the clear interface.

In still other embodiments, a method of transferring SCADA information from a sender to a receiver suitably includes the broad steps of receiving the SCADA information from a sender at a clear interface, encrypting the SCADA information using a cryptographic protocol that is independent of the SCADA information to create an encrypted data stream, and providing the encrypted data stream to a secure interface for transmission to the receiver. Further implementations include authentication of remote security devices, as well as cryptographic techniques for establishing secure and/or unsecure communications.

Other embodiments include various other systems, devices and methods, as well as data structures and other aspects of a secure SCADA environment.

### BRIEF DESCRIPTION OF THE DRAWINGS

Various aspects of the present invention will hereinafter be described in conjunction with the following drawing figures, wherein like numerals denote like elements, and:

FIG. 1 is a block diagram of an exemplary secure SCADA system;

FIG. 2 is a block diagram of an exemplary host security device;

FIG. 3 is a block diagram of an exemplary remote security device;

FIG. 4 is a flowchart of an exemplary process for operating a secure SCADA system;

FIG. 5 is a data flow diagram of an exemplary process for authenticating remote security devices in a secure SCADA system;

FIG. 6 is a data flow diagram of an exemplary process for initiating secure communications in a secure SCADA system;

FIG. 7 is a data flow diagram of an exemplary process for entering a pass-through mode of a secure SCADA system;

FIG. 8 is a block diagram of an exemplary data structure for secure or unsecure SCADA communication; and

FIG. 9 is a flowchart of an exemplary process for encrypting data in a secure data communications environment.

### DETAILED DESCRIPTION OF EXEMPLARY EMBODIMENTS

The following detailed description is merely exemplary in nature and is not intended to limit the invention or the application and uses of the invention. Furthermore, there is no intention to be bound by any theory presented in the preceding background of the invention or the following detailed description of exemplary embodiments.

According to various exemplary embodiments, SCADA systems are made more secure by providing an additional security module for each SCADA component. The security module suitably creates a secure connection with one or more other security modules using authentication and/or cryptographic techniques. After the secure connection is in place, the security module encrypts SCADA information sent from the component to the network prior to transmission, and conversely decrypts secure data received from the network. In various further embodiments, the cryptographic techniques used are independent of the underlying SCADA information being transmitted, thereby allowing many of the techniques, systems and devices described herein to be readily applied in conventional SCADA implementations without significant modification. Moreover, by placing a master encryption/decryption module at the SCADA control host, users can actively monitor the entire SCADA network in a secure manner, as described more fully below.

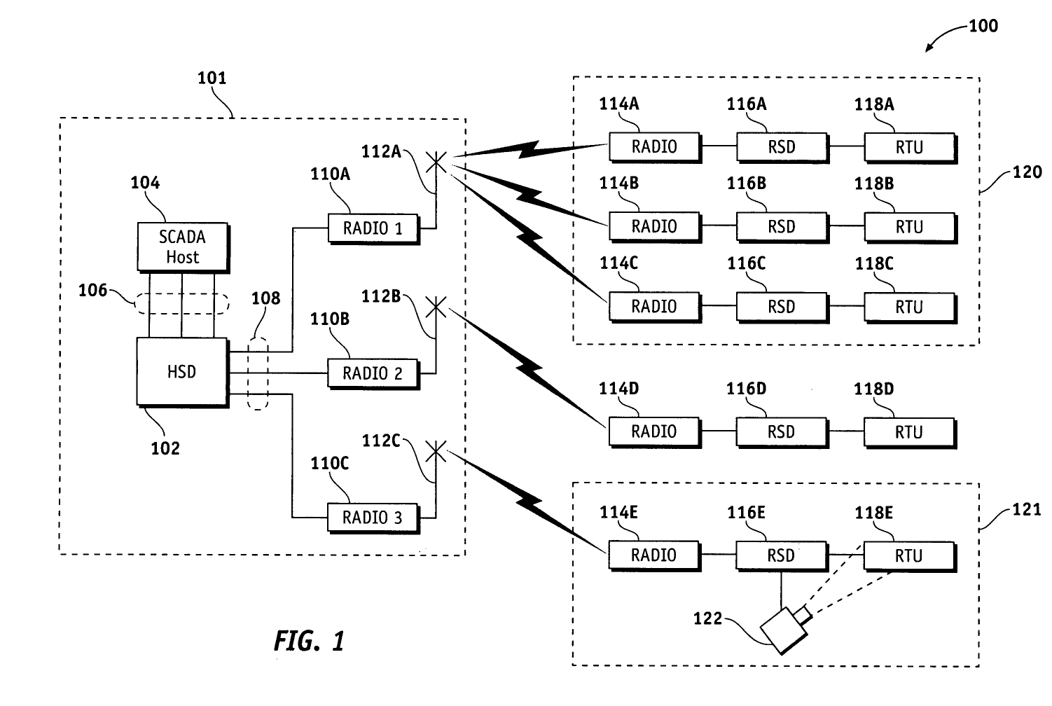

Turning now to the drawing figures and with initial reference to FIG. 1, an exemplary SCADA system/environment 100 suitably includes a SCADA control host system 101 that communicates with any number of SCADA remote terminal unit systems 121 to obtain sensor data, to provide control instructions and/or for other purposes. Both host system 101 and remote systems 121 include security devices 102, 116 (respectively) that encapsulate SCADA information within secure data structures, thereby preventing unauthorized interception, monitoring or tampering.

SCADA control host system 101 suitably includes a SCADA control host 104 connected to a host security device (HSD) 102 via one or more data connections 106. HSD 102 is in turn connected to one or more transceivers 110A-C via secure data connections 108 as appropriate.

Each transceiver 110A-C communicates with one or more remote transceivers 114A-E via any hardwired, wireless or other network. In the exemplary embodiment shown in FIG. 1, host transceivers 110A-C are connected to antennas 112A-C for communicating with remote transceivers 114A-E via wireless links, although alternate embodiments may make use of any digital and/or analog communications media, including satellite links, radio frequency (RF) communications, telephone connections, local and/or wide area data networks, or any other communications media. Accordingly, transceivers 110A-C (as well as remote transceivers 114A-E) may be implemented with any type of RF transmitter/receiver, network interface, radio, modem or other communications device depending on the particular network implementation.

SCADA control host 104 is any host, server or other computing center capable of processing SCADA information. SCADA control host 104 may be implemented on any computing platform, including any workstation, personal computer or the like running any operating system, or may be implemented using specialized hardware and/or computing environments Control host 104 typically includes software modules and/or processing routines for receiving sensor data and/or user inputs, for processing the data and inputs to determine appropriate control signals, and for providing the control signals to the appropriate remote instrumentation using the network structures described above. Many different implementations of SCADA control hosts 104 are available from various suppliers.

The various data communications between SCADA host 104 and RTUs 118A-E are referred to herein as “SCADA information”. SCADA information processed and transmitted by control host 104 may be formatted in any manner. A number of conventional SCADA protocols including the MODBUS and DNP3 protocols, for example, are described in publicly-available documents. Many products using these and other open or proprietary SCADA protocols and formats are available from many different commercial sources. As described further below, secure communications in SCADA system 100 are provided by HSD 102 and by RSDs 116A-E, allowing secure communications that are not dependent upon the underlying SCADA protocols. Indeed, security may be implemented in a manner that is transparent to SCADA host 104 and remote units 118A-E, thereby allowing wide application across a diverse array of existing and subsequently developed SCADA systems 100.

To that end, HSD 102 is any device, processing card, software application or other module capable of transparently encrypting and decrypting SCADA information to thereby establish secure communications between SCADA control host 104 and one of more remote terminal systems 121. Security device 102 may be further configured to authenticate RSDs 116A-E prior to establishing secure communications, and may additionally provide various control instructions to RSDs 116A-E, including instructions to update software, to reboot, to disable secure communications and/or the like, as described more fully below.

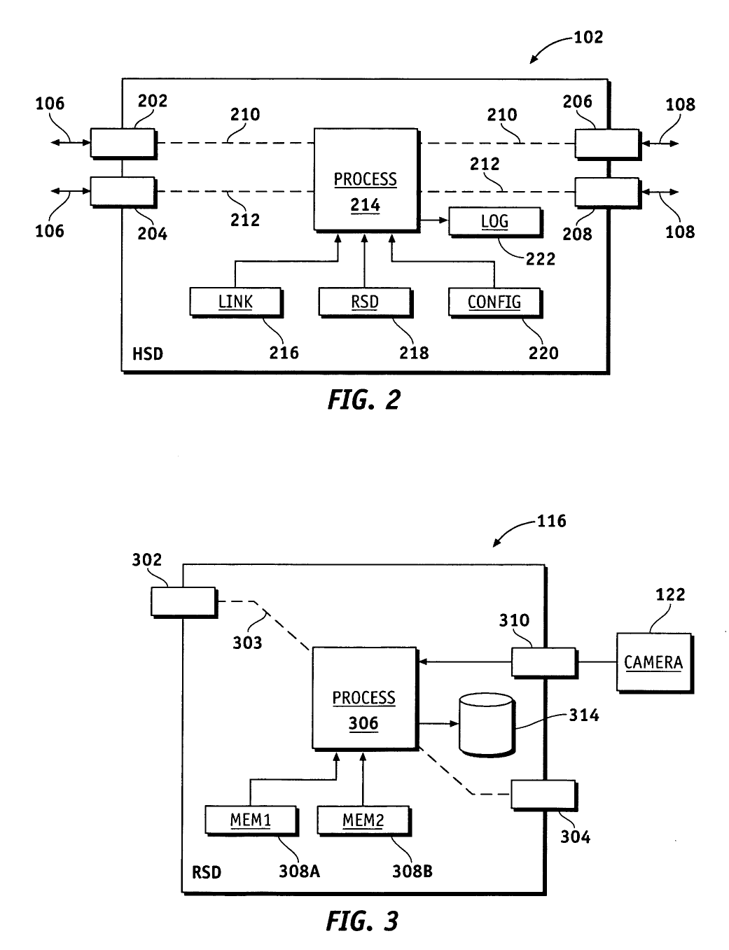

HSD is generally implemented as a passive hardware and/or software module that is capable of encapsulating SCADA information within a secure dataframe without impacting the rest of SCADA network 100. Although HSD 102 is shown as a separate device from SCADA host 104, this distinction is intended as logical in nature. The various functions associated with HSD 102 may be implemented in hardware, software and/or any combination of hardware and software, and in practice may be physically implemented within the same computer or other processing device as SCADA host 104. An exemplary HSD 102 is described in additional detail in conjunction with FIG. 2 below.

Data connections 106 and 108 coupling HSD 102 to SCADA host 104 and transceivers 110A-C, respectively, may be implemented in any manner. In various embodiments, these connections are logical connections over a bus or other communications structure within a common computing host or other device. Alternatively, connections 106 and 108 may be serial, parallel or other connections as appropriate. Examples of serial technologies that could be used in various embodiments include conventional RS-232 serial, universal serial bus (USB), IEEE 1394 (“Firewire”) and the like, although other embodiments may use any other type of open or proprietary communications schemes.

Each remote terminal system 121 suitably includes a remote terminal unit (RTU) 118, a remote security device (RSD) and a transceiver 114 as discussed above. RTU 118A-E is any conventional SCADA remote station, including any type of RTU, programmable logic controller (PLC) or the like. Typically, RTU 118 is a ruggedized computer system capable of communicating with a sensor, valve, switch or other type of field instrumentation to implement a desired SCADA monitoring or control function. Various standard and proprietary implementations of SCADA RTUs 118 are commercially available from a variety of vendors. Transceivers 114A-E are similarly implemented with any type of conventional wired or wireless communications equipment as described above. Although not shown in FIG. 1, transceivers 114A-E may interoperate with an internal or externally-connected antenna to facilitate wireless communications as appropriate.

Each RSD 116 is a device, processing card, software application or other module capable of securing communications between one or more RTUs 118A-E and HSD 102. Like HSD 102, each RSD 116A-E is generally implemented as a passive hardware and/or software module that is capable of encapsulating SCADA information within a secure wrapper without impacting the rest of SCADA network 100. Additional detail of an exemplary RSD 116 is presented below in conjunction with FIG. 3.

In various embodiments, remote system 121 further includes one or more optional cameras 122 for obtaining and recording visual information about RTU 118. Still-frame or motion video images may be obtained using camera 122, for example, to further improve the security of remote system 121. In embodiments that include cameras 122, video images may be stored within RTU 118 and/or RSD 116 as appropriate to allow such images to be retrieved and viewed if the RTU is tampered with or damaged. Alternatively, video images may be provided to HSD 102 or SCADA host 104 to aid in remotely monitoring system 121. Cameras may be optionally configured with motion sensors, light sensors or the like to detect movement or human presence in the vicinity of RTU 118 to further improve the efficiency and effectiveness of video security. Again, video security and camera 122 are optional features that may be implemented in certain embodiments, and are not required for the practice of the general concepts set forth herein.

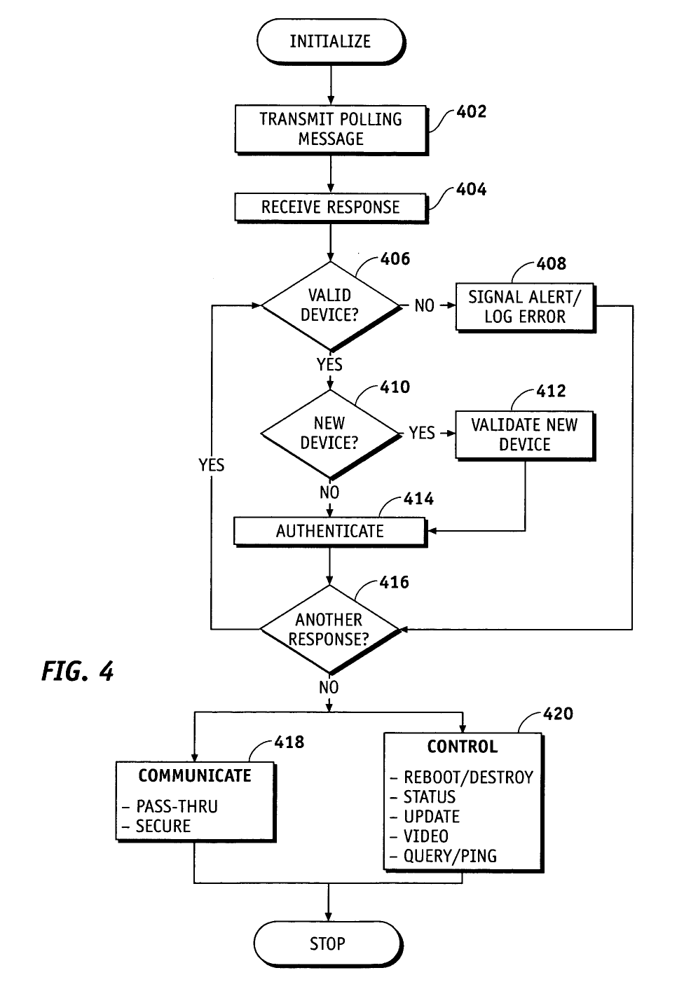

In operation, then, SCADA host 104 communicates with the various RTUs 118A-E to obtain sensor data and to provide control instructions as appropriate, which security devices 102 and 116A-E provide authentication and encryption as desired. Communications may be provided in a secure mode to prevent unauthorized reception or tampering. Further, various embodiments may provide a “pass-through” mode in which encryption is disabled for certain non-secure transmissions, broadcasts or the like. Data communications may be established in a point-to-point manner (e.g. as shown between host transceiver 110B and remote transceiver 114D in FIG. 1), or may be established with multiple remote transceivers 114 tuned to a common radio frequency or otherwise connected in a shared communications configuration to receive broadcasts from a single host transceiver 110, thereby creating a broadcast group 120 (e.g. as shown by host transceiver 110A and remote transceivers 114A-C in FIG. 1). In a broadcast group configuration, each RSD 116 may be individually addressed using any convenient addressing scheme. Further, HSD 102 may communicate with each RSD 116A-C in broadcast group 120 using a cryptographic key that is unique to that RSD, thereby making secure transmissions unintelligible to other RSDs that are not in possession of the unique key. Additional detail about exemplary cryptographic techniques for authenticating and securing communications is provided below in conjunction with FIGS. 4-7, as well as FIG. 9.

Referring now to FIG. 2, an exemplary HSD 102 suitably includes one or more clear interfaces 202, 204, a process module 214 and one or more secure interfaces 206, 208. HSD 102 may be implemented in any manner. As briefly discussed above, HSD 102 may be implemented on a physically distinct computer system from SCADA host 104. An Intel-based personal computing platform running the LINUX operating system, for example, could be used in an exemplary embodiment, although other embodiments may use widely varying hardware and/or software platforms. Alternatively, HSD 102 may be partially or entirely integrated into SCADA host 104 as appropriate. In still further embodiments, HSD 102 is implemented in software running on SCADA host 104.

Interfaces 202, 204, 206 and 208 are any type of actual or virtual interfaces to SCADA host 104 and/or transceivers 110. Such interfaces may be software ports to various other computing processes, for example, or may be implemented with serial or parallel ports within a computing host. In an exemplary embodiment, interfaces 202, 204, 206 and 208 are RS-232 standard serial ports, although other serial or parallel technologies (e.g. USB, IEEE 1394 and the like) could be used in alternate embodiments. It is not necessary that each interface be of the same type; indeed, some or all of the interfaces 202, 204, 206 and 208 may be implemented with unique and varying interface techniques. Moreover, any number of clear and/or secure interfaces could be used in various alternate embodiments, with the number of clear interfaces being equal or unequal to the number of secure interfaces.

Process module 214 suitably creates virtual connections 210, 212 linking clear interfaces 202, 204 and secure interfaces 206, 208 such that data arriving at one interface is processed and output to the other interface in the link, and vice versa. Data passed between the clear and secure interfaces may be simply “passed through” HSD 102 without encryption, or may be encrypted/decrypted depending upon the then-current operating mode of HSD 102. Although FIG. 2 shows virtual connections 210, 212 as connecting each clear interface 202, 204 to a unique secure interface 206, 208, alternate embodiments may create virtual connections that switch, multiplex and/or demultiplex communications between one or more interfaces. Incoming communications from SCADA host 104 may be multiplexed in a one-to-many scheme to multiple transceivers 110, for example, or communications received from one or more transceivers 110 may be directed to multiple SCADA hosts 104 (or multiple ports on a single SCADA host 104) in alternate embodiments.

Process module 214 also communicates with any number of other data sources as appropriate. In the exemplary embodiment shown in FIG. 2, for example, HSD 102 further includes a link table 216, an RSD table 218 and a configuration table 220, as well as a data log 222. Alternate embodiments may include additional, fewer and/or alternate data sources as appropriate. These data sources may be stored in memory or mass storage within HSD 102, or alternatively may be obtained from remote data sources, including memory or mass storage affiliated with SCADA host 104.

Link table 216, for example, may be used to identify port numbers associated with each interface 202, 204, 206, 208, as well as the relationships or mappings between the various ports/interfaces. Link table 216 may also maintain communications parameters for each virtual link, including link data rate, hardware or software flow control parameters, data compression or encryption parameters and/or the like. HSD 102 may also maintain a listing of RSD data 218 with such information as remote device identification data, remote device master key information, assignments to virtual links and the like. HSD 102 may further contain a database or listing 220 of configuration parameters, including default values, timeout and retry settings, or other parameters that apply to the overall HSD 102. Such parameters may be set or updated according to user preferences or other factors. Each table 216, 218 and 220 may be stored in random access memory (RAM) associated with HSD 102, or in any other appropriate location.

Similarly, HSD 102 may be configured to maintain a log 222 in memory, mass storage or another appropriate location. Log 222 suitably maintains information to allow for forensic analysis in the event of a security breach, system crash or other event. Such information may include records of configuration changes and administration events occurring at HSD 102, device ID recognition events (e.g. discovery of invalid devices or valid devices on invalid links, as described below), link activity (e.g. data dumps), cryptography-related packet activity (e.g. for a specific remote device), and/or other information.

HSD 102 may have additional features as well. HSD 102 may provide a graphical or textual user interface, for example, to allow an operator to make configuration changes, to review or retrieve data stored in log 222, or for other purposes. The interface may include user authentication/authorization, including one or more levels of security and associated access privileges. Further, HSD 102 may have a floppy drive, CD ROM drive, network interface, modem interface or the like to allow for data backups, software upgrades, and/or remote access by administrators, service technicians, and/or other approved users.

With reference now to FIG. 3, an exemplary remote security device (RSD) 116 suitably includes a clear interface 304 and a secure interface 302 logically interconnected by a process module 306 that encrypts/decrypts data passing between the two interfaces. RSD 116 may be implemented with a printed circuit board (PCB) or other data processing card, with one or more software modules, and/or with a standalone computing device. In an exemplary embodiment, RSD 116 is implemented with a microcontroller-powered circuit card that is optionally contained within a housing. Again, alternate embodiments of RSDs 116 could be formulated on any hardware and/or software platforms or environments.

RSD 116 suitably includes one or more memory modules 308A-B for storing data and instructions for processing module 306. Memory modules 308A-B may be implemented with any type of static, dynamic or flash memory, for example, or any other type of data storage media. FIG. 3 shows two memory modules 308A-B to facilitate software or firmware upgrades without risk of “crashing” RSD 116 if the upgrade does not complete successfully, although such redundancy is a feature that is not required in all embodiments.

Each interface 302, 304 may be a logical port or actual serial, parallel or other interface for connecting cabling to RTU 118 and/or transceiver 114. In an exemplary embodiment, interfaces 302, 304 are conventional DB-9 or DB-25 RS-232 serial ports, although any other type of serial, parallel or other interface could be used in alternate embodiments. The various interfaces 302, 304 may be configured in any manner, using any convenient data rate, hardware or software flow control, and the like. Further, although FIG. 3 shows RSD 116 as having only a single secure interface 302 and a single clear interface 304, alternate embodiments may include two or more secure and/or clear interfaces as appropriate. Such embodiments may enable RSD 116 to simultaneously support multiple RTUs 118 and/or multiple transceivers 114.

Process module 306 is any hardware and/or software module capable of controlling the various features and functions of RSD 116. In various embodiments, process module 306 suitably maintains virtual connection 303 between secure interface 302 and clear interface 304. Process module 306 also negotiates with the HSD 102 to establish and maintain secure communications, as well as to process any control data as described more fully below. In various embodiments, RSD 116 defaults to a “pass-through” (i.e. unsecure) mode at power-up, and remains in this mode until instructed by an HSD 102 to enter a secure mode. During secure mode, processing module 306 suitably encrypts data received from RTU 118 via clear interface 304 and decrypts data received from HSD 102 via secure interface 302. In various embodiments, processing module 306 reduces latency by providing decrypted data to RTU 118 before RSD 116 fully buffers and verifies that a complete encryption packet has been received. Because large packet data streams may be provided to RTU 118 before the receiving and decrypting processes are complete, RSD 116 is able to very efficiently handle SCADA information with little or no modification to the underlying SCADA protocols. Exemplary cryptographic techniques are described more fully below in conjunction with FIGS. 4 and 9.

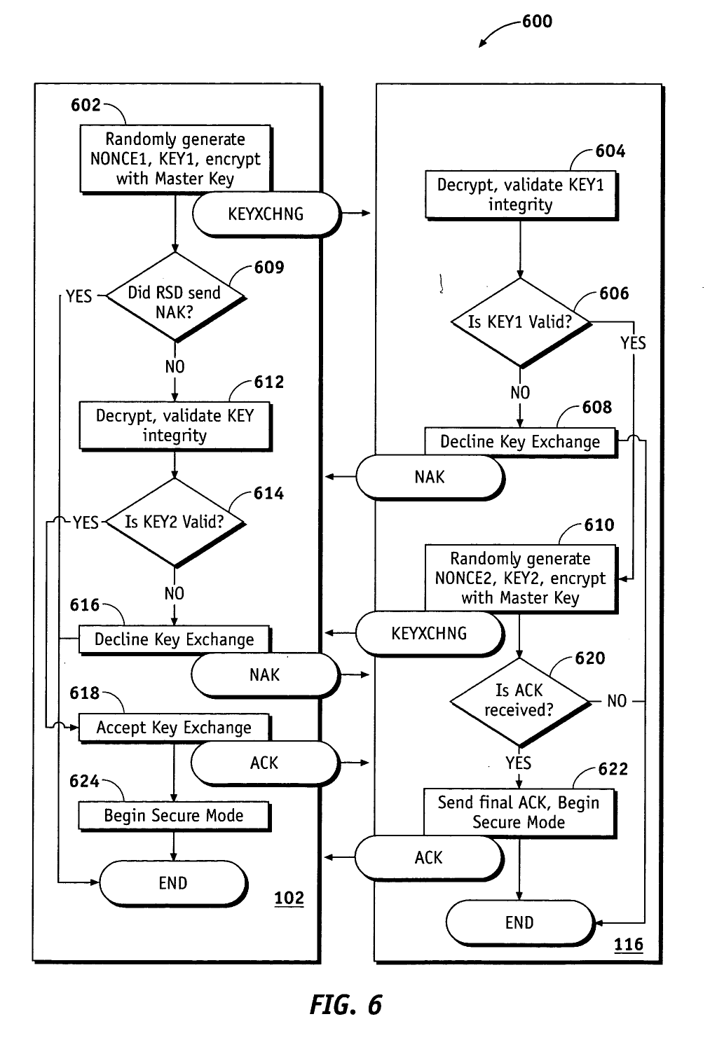

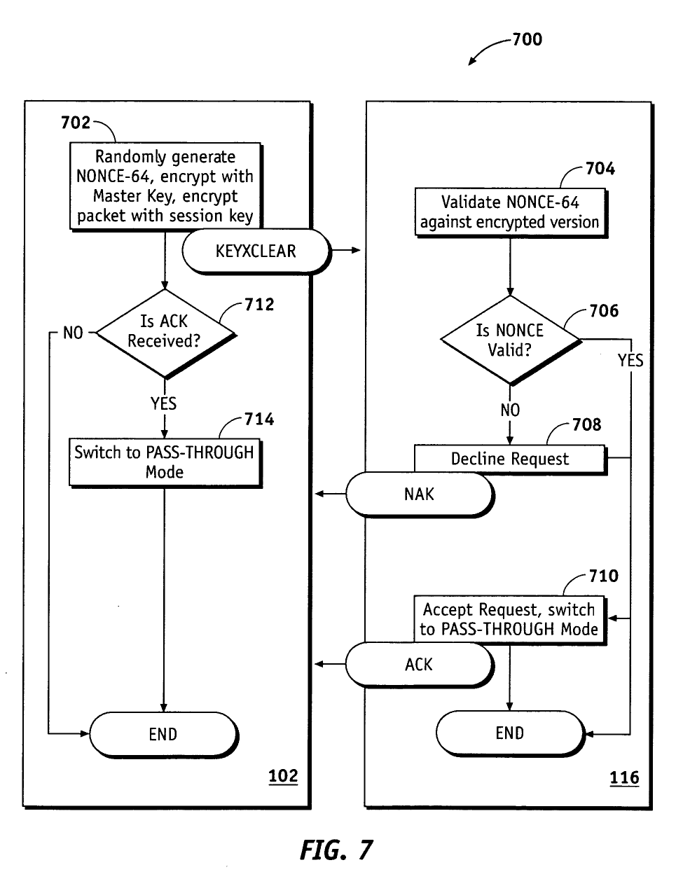

Processing module 306 suitably remains in secure mode until instructed by HSD 102 to return to pass-through mode or until RSD 116 is reset or rebooted. Exemplary techniques for entering secure and pass-through modes are described below in conjunction with FIGS. 6 and 7. Additionally, processing module 306 may continually monitor data passing through virtual connection 303 to identify “host signatures”, polling requests and/or other control messages sent from HSD 102.

Programming for RSD 116 may take place in any manner. In various embodiments, RSD 116 is built on a platform that supports development in any conventional programming language, such as the JAVA programming language available from Sun Microsystems of Sunnyvale, Calif. Security may be further enhanced through the use of dongles, hardware keys or other physical security devices. In such embodiments, the dongle or other device must be physically present in interface 302, interface 304 or another interface in RSD 116 to enable programming, setup, troubleshooting, update or similar features. Insertion of a security device may also trigger a request for a password or other digital credential to further discourage tampering with RSD 116. Software or firmware updates may also be securely processed via HSD 102, as described more fully below.

In a further optional embodiment, RSD 116 may include or communicate with a camera 122 as briefly mentioned above. In such embodiments, camera 122 provides still-frame and/or motion video to RSD 116 via an interface 310, which may be any type of serial (e.g. USB, IEEE 1394, etc.), parallel, optical or other interface as appropriate. Images from camera 122 are suitably provided to RSD 116 for storage in a database 314 and/or for transmittal to HSD 102, SCADA host 104 and/or another appropriate recipient. Camera 122 may be useful to improve the security of RTU system 121 by providing visual images of RTU 118 at regular intervals, in response to a signal from a motion detector or other sensor, or the like.

In operation, then, RSD 116 is suitably inserted between transceiver 114 and RTU 118 in RTU system 121 to secure communications between RTU 118 and HSD 102. As with HSD 102, RSD 116 transparently encrypts and decrypts the underlying SCADA information passing through the device without regard to the underlying protocols and formats, thereby allowing RSD 116 to be readily adapted to any RTU, including legacy equipment.

Turning now to FIG. 4, an exemplary method 400 executable by HSD 102 to establish and process secure communications with any number of RSDs 116 suitably includes the broad steps of broadcasting a polling message (step 402), receiving responses from each RSD 116 (step 404), authenticating the RSDs 116 that respond (step 414), and establishing communications (step 418) and control (step 420) of the various RSDs 116. Further embodiments may contain additional steps as described below.

When HSD 102 is activated (e.g. powered up), processing module 214 suitably transmits a polling message (step 402) to identify RSDs 116 present on each remote link (e.g. the RSDs 116 that are reachable by each secure interface 208). Polling messages may also be transmitted at regular or irregular intervals to identify RSDs 116 that may have come online or dropped offline since the previous polling. Further, polling may be initiated by a human operator via a user interface to HSD 102 and/or SCADA host 104 as appropriate. In various embodiments, the initial polling message could be implemented as a simple “PING” message transmitted to a broadcast address (e.g. 0×FFFF could be arbitrarily chosen as a broadcast address in embodiments with a two byte addressing scheme) to obtain a response from each RSD 116 receiving the “PING”. Alternatively, HSD 102 could send “PING” messages addressed to one or more known RSDs (e.g. RSDs identified in tables 216 or 218) to provoke replies from only certain RSDs 116.

RSDs 116 respond to the polling message in any appropriate manner (step 404). In various embodiments, each RSD 116 sends a reply (“PONG”) message back to HSD 102 in response to the polling (“PING”) request. In other embodiments, RSD 116 determines if response is necessary.(e.g. if a response was previously sent to the same HSD 102 within a relatively recent timeframe, or if the RSD 116 is already authenticated with HSD 102), and sends the “PONG” reply only if the HSD needs such information. If a response is necessary, RSD 116 formats a “PONG” message to HSD 102 that includes the address/identification of the RSD 116, as well as any other relevant information (e.g. software version or other data) as appropriate. In further embodiments, RSD 116 waits for a period of predetermined or random period of time prior to transmitting the “PONG” message to prevent simultaneous transmission by multiple RSDs 116. In such embodiments, the PONG response may contain timing information (e.g. the wait time and/or the time of transmission) to allow HSD 102 to calculate link delay times for communications sent to RSD 116.

Upon receipt of a “PONG” message or other reply to the polling query, HSD 102 suitably validates the message (step 406) to determine if the replying RSD 116 is authorized to share SCADA information within system 100. Validation may involve comparing the RSD identification against data stored in RSD table 218 to verify that the responding RSD 116 is authorized to communication within system 100, as appropriate. Additionally or alternatively, HSD 102 compares the RSD identification against data in link table 216 or the like to confirm that RSD 116 is communicating on the proper link (i.e. is associated with a proper broadcast group 120). Validating RSD 116 in this manner prevents unscrupulous users from placing rogue RSDs 116 within the system or from moving legitimate RSDs 116 from one place to another. If a rogue RSD 116 is identified in step 406, HSD 102 suitably provides an alert to an operator (step 408) as appropriate. Alerts may be visual, audible or otherwise in nature, and/or the event may simply be recorded in log 222 for further evaluation at a later time. HSD 102 may perform additional validation to further improve the security of system 100 as appropriate.

HSD 102 may also automatically identify new RSDs 116 (step 410) as appropriate. Although this step is shown distinct from step 406 in FIG. 4, in practice steps 406 and 410 may be combined in any manner. If a new RSD 116 responds to the polling message, the new device may be recognized and validated (step 412) in any appropriate manner. An operator may be prompted to approve the new RSD 116, for example, before allowing the new device to communicate within system 100. Upon validation, entries for the new RSD 116 may be made in data list 218 or elsewhere as appropriate.

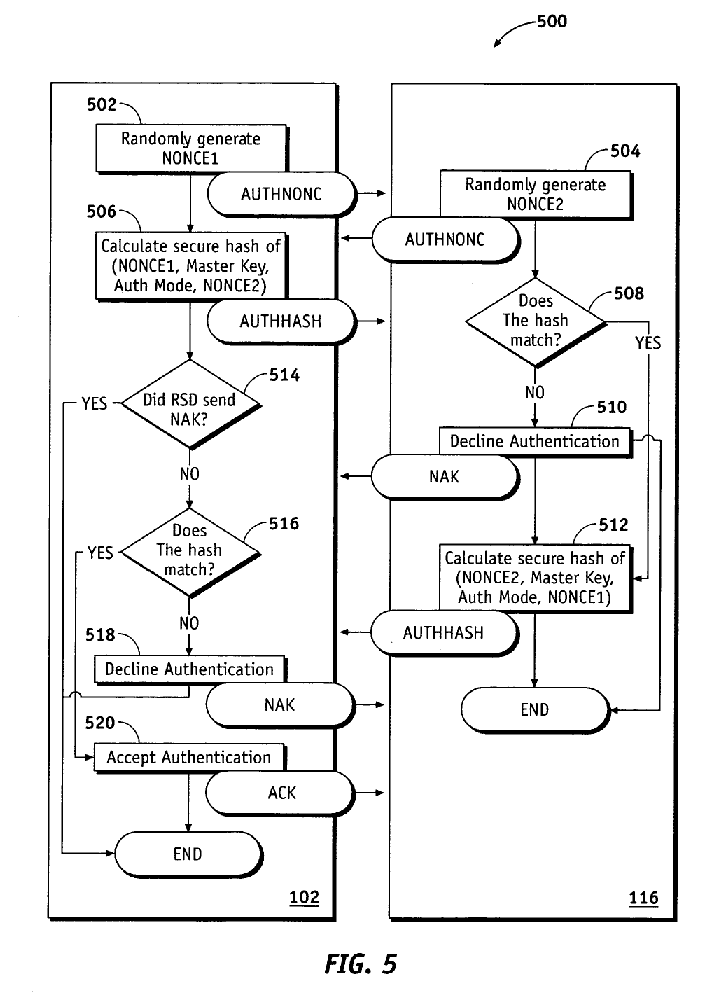

To further improve security, each RSD 116 appropriately authenticates with HSD 102 to further verify that the RSD 116 is authorized to transmit and receive SCADA information within system 100. Authentication involves proving the identity of the RSD 116 by providing a digital signature or other credential from RSD 116 to HSD 102. One technique for authenticating RSD 116 and HSD 102 to each other is described below in conjunction with FIG. 5.

RSD recognition, validation and authentication continues (step 416) until each of the RSDs 116 operating within a broadcast group 120 are identified and processed as appropriate. When an RSD 116 is properly authenticated, data communications proceed as appropriate. Communications may include data packets (step 418) and/or control packets (step 420) for configuring the actions taken by one or more recipient RSDs 116. For standard data communications (step 418), SCADA information between the secure interfaces of HSD 102 and RSD 116 in a secure manner, or in “pass-through” mode. As briefly described above, data transmitted in “pass through” mode is not typically encrypted, but rather is sent “in the clear”. While such transmissions may be susceptible to interception and/or tampering, “pass through” messages may be used to efficiently transmit non-sensitive information and the like. For information sent in secure mode, the transmitting security device appropriately encrypts the SCADA information stream using an appropriate cryptographic technique to prevent interception or tampering during transmission. Although any block or stream cipher could be used to secure data transmitted in this mode, exemplary embodiments make use of conventional stream ciphers such as the RC4, SOBER, SNOW, LEVIATHON or other cryptography algorithms. In other embodiments, block ciphers such as DES, AES or the like may be used. In still further embodiments, SCADA information is encrypted and immediately transmitted upon receipt of SCADA information; that is, the security device does not wait for a complete SCADA message to be received to begin encrypting and transmitting encrypted data. Similarly, received secure data can be readily decrypted and forwarded to the SCADA component associated with the security device before the encrypted data is entirely received at the secure interface. As mentioned above, this immediate processing of received data reduces latency in processing, particularly on large data packets.

Control messages (step 420) may be sent as out-of-band or other messages to provide information, to place a remote security device into a desired operating state, or to provide other instructions to remote security devices as appropriate. In various embodiments, each HSD 102 and RSD 116 scans each message header to identify relevant control messages. Each control message may be formatted according to a pre-defined protocol, with each control data recipient being programmed to recognize and process control data packets as appropriate. Examples of functions that can be carried out by control data packets include information queries (e.g. status requests, “PING” messages and the like), instructions to reboot or reformat a remote device, software/firmware upgrades and the like. In various embodiments, RSDs 116 may be configured to “self destruct” (e.g. to become inoperable, or at least disable secure communication capability) in response to a control data packet encrypted with a particular key or otherwise formatted in an appropriate manner. Control data packets may also be used to request and transfer video images from camera 122, database 314 and/or another source as appropriate. Many other control features could be implemented in a wide array of alternate but equivalent embodiments.

FIGS. 5-9 describe exemplary cryptographic techniques and structures, although any other symmetric, asymmetric or other cryptographic techniques may be used in a wide array of alternate embodiments. With reference now to FIG. 5, an exemplary process 500 for authenticating RSD 116 and HSD 102 to each other suitably includes the broad steps of generating random nonces at HSD 102 and RSD 116 (steps 502, 504), calculating secure hashes as functions of the two nonces (steps 506, 512) and checking that the hashes created by each device match to verify that the remote device is indeed authorized to communicate within system 100 (steps 508, 516). Process 500 suitably verifies that both HSD 102 and RSD 116 are in possession of a “master key”, which is a bit sequence of any length that is unique to an HSD 102 and all RSDs 116 in secure communication with the HSD 102. Alternatively, each RSD 116 may be associated with its own cryptographic key, with a copy of each RSD key being stored with HSD 102. In such embodiments, process 500 verifies that both the HSD and RSD are in possession of the same RSD key as appropriate. In other equivalent embodiments, asymmetric cryptography (e.g. public and private key pairs) could be used.

Authentication process 500 suitably begins with HSD 102 and RSD 116 each generating a random bit stream (steps 502 and 504, respectively). The bit stream may be of any length (e.g. on the order of one to eight bytes), and is referred to herein as a “nonce”. In various embodiments the nonces are approximately thirty-two bits in length, and are randomly generated according to any technique. The nonces are exchanged between HSD 102 and RSD 116 as appropriate.

After receiving the nonce from RSD 116, HSD 102 suitably calculates a hash value using the two nonces and the master key (step 506). The hash is any bit sequence computed as a duplicatable function of the input data. In various embodiments, the hash is a “digest” that verifies the contents of the input data. Various hash and digest algorithms are known in the cryptographic arts, including the SHA-1 algorithm defined in FIPS-186-2, as well as the MD2, MD4 and MD5 described in numerous public resources. The calculated hash is then transmitted from HSD 102 to RSD 116.

Upon receipt of the calculated hash from HSD 102, RSD 116 also computes a hash or digest using the same algorithm and input data used by HSD 102. If the underlying input data (e.g. the two nonces and the master key) processed by RSD 116 and HSD 102 are identical, then the two resulting hashes should be identical to each other (step 508). If the hash calculated by RSD 116 does not match the hash received from HSD 102, then authentication is declined by RSD 116 (step 510) and a negative acknowledgement (“NAK”) message is transmitted to HSD 102. If the two hashes match, however, the RSD 116 has verified that HSD 102 properly received the nonce previously transmitted, that RSD 116 properly received the nonce transmitted by HSD 102, and that the two devices are in possession of the same master key. RSD 116 then processes a second hash using the same input data (e.g. by reversing or otherwise modifying the order of the input data, or by modifying the input data in any other predictable manner) and transmits this second hash to HSD 102 (step 512).

If HSD 102 receives the “NAK” message from RSD 116 (step 514), HSD 102 suitably concludes that authentication did not succeed. If a second hash is received, however, HSD 102 attempts to duplicate the hash using techniques similar to those described above. If the HSD 102 is able to verify the second hash calculated by RSD 116, then authentication is accepted (step 520) and the RSD 116 is trusted or otherwise allowed to communicate within system 100. Alternatively, if the hash is not verified, RSD 116 is not trusted and authentication is denied (step 518). Authentication results may be logged (e.g. in log 222) in any manner, and/or any authentication denials may be flagged or signaled to an operator for subsequent action. Authentication denial could result from rogue devices communicating within network 100, but also could result from communications errors, system malfunctions or other factors that may be investigated as appropriate.

After HSD 102 and RSD 116 are authenticated to each other, secure (and unsecure) communications can take place. With reference to FIG. 6, an exemplary process 600 for initiating secure mode information exchange suitably includes the broad steps of each device generating random nonces and session keys (steps 602, 610), validating the keys generated by the other devices (steps 606, 614), and acknowledging successful validation of the session keys (steps 618, 622). Process 600 allows HSD 102 and RSD 116 to generate and exchange session keys to allow transmission and receipt of encrypted packets.

The transition to secure mode suitably begins with HSD 102 randomly generating a nonce and a session key. Once again, the nonce is a random bit stream of any length that is used to prevent “replay” attacks (i.e. attacks wherein a hostile party “records” digital packets and plays them back at a later time). Since the nonce changes each time the devices enter secure mode, packets replayed at a later time will be invalid after the nonce embedded in the message expires. The session key is any bit stream capable of use as a cryptographic key in sending or receiving secure data. While key formats vary from embodiment to embodiment, exemplary types of cryptographic keys are the result of numerical functions such as elliptical functions, products of prime numbers and the like. After generating a nonce and session key, HSD 102 suitably formats a “key exchange” message that includes the key, the nonce and information that allows the key to be verified by RSD 116. Such information may include a hash, digest or cyclic reduction code (CRC) of the key and/or nonce. In various embodiments, the verification information is a CRC-32 digest of the key. This information is arranged in a suitable format, encrypted with the master key for the HSD 102, and transmitted to RSD 116.

RSD 116 receives the key exchange message from HSD 102 and decrypts the message to extract the session key and nonce (step 504). The key is validated using the validation information contained within the message (step 506) to verify that the proper key has been received. If RSD 116 is unable to validate the key (step 508), a negative acknowledgement (“NAK”) is sent back to HSD 102.

Although not strictly necessary, using separate session keys for transmission and receipt of data further enhances the security of system 100 by making communications interception and tampering much more difficult for a hostile party. Upon successful validation of the HSD session key, then, RSD 116 suitably generates its own key and nonce for the secure session (step 610). The key and nonce are formatted in a key exchange format with validation information and encrypted using the master key. The encrypted message is then transmitted to HSD 102 for further validation and processing.

If HSD 102 receives a “NAK” message from RSD 116 (step 609), secure mode is aborted. If HSD 102 receives a key exchange message from RSD 116, however, the message is decrypted, and RSD key is validated using the CRC or other validation information contained in the message (step 612). If HSD 102 is able to validate the received session key (step 614), then the key is accepted and an acknowledgement message is sent to RSD 116 (step 618). Otherwise, key exchange is declined, a negative acknowledgement (“NAK”) is sent to RSD 116, and processing is terminated (step 618).

When RSD 116 receives an acknowledgement, RSD 116 enters secure mode (step 622) and transmits a final acknowledgement (“ACK”) to HSD 102, which then enters secure mode upon receipt of the acknowledgement (step 624). When both HSD 102 and RSD 116 are operating in secure mode, SCADA information transmitted on each outgoing secure interface (e.g. interfaces 206, 208, 302 in FIGS. 2-3) is encapsulated in a security frame and encrypted as appropriate. Other information (e.g. control information, status requests and other non-sensitive data) may be transmitted without encryption, even when the device is operating in secure mode. Each device suitably uses its generated session key to encrypt data, and the received session key to decrypt data as appropriate. Other embodiments, however, may operate in the opposite manner, using the generated session key as a decryption key and the received key as an encryption key. Again, the various cryptographic techniques described herein may be modified in any manner, and any other techniques may be used with a wide array of equivalent embodiments.

When the RSD 116 is no longer expected to transmit secure data, it may be placed back into pass-through mode using any appropriate technique. With reference to FIG. 7, an exemplary technique 700 for taking an RSD 116 out of secure mode suitably includes the broad steps of generating a “key clear” message (step 702) at HSD 102, validating the message at RSD 116 (step 706), and then returning to pass-through mode (steps 710, 714) as appropriate.

Process 700 suitably begins with HSD 102 formatting a “key clear” message (step 702) that includes a newly-generated random nonce (e.g. a sixty-four bit nonce, or a nonce of any other length). The nonce is appropriately encrypted with the master key, and a message if formatted containing the nonce in both encrypted and non-encrypted format. The entire message is then encrypted with the session key for the secure mode session and transmitted to RSD 116 as appropriate.

Upon receipt of a key clear message, RSD 116 suitably decrypts the message to extract the new nonce (step 704). The encrypted nonce contained in the message is decrypted using the master key, and the resulting nonce is compared to the unencrypted nonce contained in the message to validate the nonce (step 706). If the nonce is valid, RSD 116 accepts the request, switches to pass-through mode, and transmits an acknowledgement (“ACK”) to HSD 102 (step 710). If the RSD 116 is unable to validate the nonce, the pass-through request is denied, a negative acknowledgement (“NAK”) is sent to HSD 102, and communications continue in secure mode (step 708). If HSD 102 receives the acknowledgment (step 712), HSD 102 switches to pass-through mode for communications to that RSD 116. HSD 102 may continue to communicate with other RSDs in system 100 in secure mode, as appropriate. To return RSD 116 to secure mode, new session keys are generated and validated as described above. Accordingly, processes 600 and 700 may be used to “clear” the session keys and create new keys even when continued secure communication is desired. Resetting the session keys on a periodic or a periodic basis improves the security of system 100 by making key interception more difficult, and by shortening the window of opportunity for successful replay attacks.

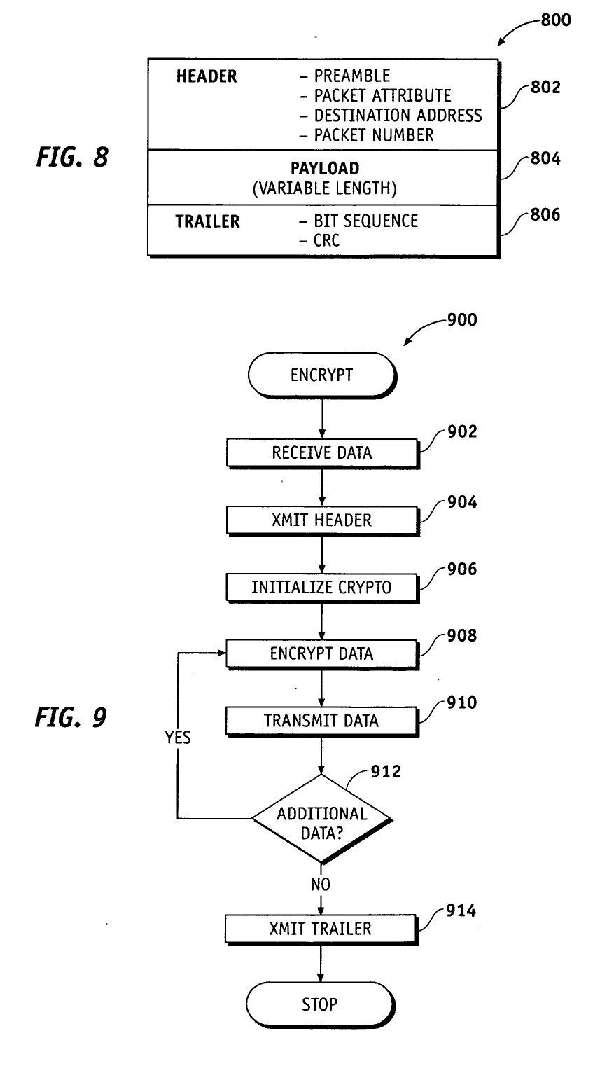

Secure data transmissions may be made within system 100 using any cryptographic and data communications formats. In various embodiments, SCADA information is appropriately encrypted using a stream cipher or the like, and the encrypted data is encapsulated within an appropriate data frame. With reference now to FIG. 8, an exemplary data structure 800 suitable for transmitting encrypted SCADA information suitably includes a header 802, a payload 804 and a trailer 806. Each of these data fields suitably contains digital information that can be exchanged between HSD 102 and any number of RSDs 116A-E.

Data structure 800 may be used with either control packets and/or data packets. In various embodiments, header field 802 and trailer field 806 have a fixed length, with the payload field 804 having a variable length that is dependent upon the amount of data being transmitted. In an exemplary embodiment, header field 802 is defined as having about sixteen bytes of information and trailer field 806 is defined with about four bytes of information, although fields of any length could be used in alternate embodiments.

Header field 802 suitably includes metadata about data structure 800 and/or about data contained within payload field 804. In various embodiments, header field 802 suitably includes a preamble (e.g. a predefined bit sequence that identifies the beginning of a packet), packet attribute data (e.g. two or three bits identifying the packet as a data packet, control packet or the like), an address of a destination (e.g. a one to four byte address of the data receiver; broadcast messages may be sent to a “broadcast address” such as 0×FFFF), and a packet identifier (e.g. a number that indicates the packet's place in a multi-packet data sequence and/or provides an initialization vector for a cryptography engine). An exemplary trailer field 806 suitably includes a CRC, digest or other information to allow verification of data contained within message 800. Trailer field 806 may also include a pre-determined bit sequence that indicates the beginning of the trailer in various embodiments. Other embodiments, however, may incorporate widely varying data formats, with alternative or additional information stored in the packet header 802 and trailer 806.

Referring now to FIG. 9, an exemplary process 900 for encrypting SCADA information for transmission to a remote receiver suitably includes the broad steps of receiving the SCADA information (step 902), transmitting the header field 802 (step 904), encrypting and transmitting the payload data stream 804 (steps 908, 910), and transmitting trailer field 806 (step 914) as appropriate. Alternate embodiments may deviate from process 900 in any manner, and/or may include additional or alternate steps to those shown in FIG. 9.

When SCADA information is received at HSD 102 or RSD 116 (step 902), the security device creates data packets 800 to encapsulate and encrypt bytes of data received at the clear interface. The incoming bytes generally consist of part or all of a packet from the underlying SCADA protocol, although the techniques described herein may be used with any type of information and/or any underlying data formats or protocols.

Upon receipt of SCADA information on the clear interface, the security device appropriately formats a header field 802 as described above (step 904). As noted above, header field 802 appropriately contains meta-data about the packet 800 and/or payload 804, and provides the data recipient with information to allow proper decryption and/or processing of the payload data 804. In various embodiments, header 802 may be provided to the secure interface or otherwise transmitted to the recipient immediately upon receipt of SCADA information, or at least as soon as the security device has enough information about payload field 804 to formulate a suitable header 802. By transmitting header 802 while payload data 804 is still being received/processed, latency in transmission may be significantly reduced.

Prior to processing the packet payload 804, the security device initializes the cryptography engine (i.e. the portion of process module 214 or 306 that allows for digital encryption) as appropriate (step 906). Initialization may involve setting an initialization vector (e.g. corresponding to the packet number contained in header field 802) to provide a seed for random number generation or the like. Although FIG. 9 shows initialization (step 906) taking place immediately after header transmission (step 904), in practice this initialization may take place prior to or simultaneously with header transmission.

When the cryptography engine is initialized, encryption of the payload bytes (step 908) may commence. As noted above, encryption may take place using any technique or algorithm, including any block or stream cipher presently known or subsequently developed. In an exemplary embodiment, bytes of SCADA information are processed as they are received at the clear interface using the encryption algorithm and the session keys described above, and encrypted data is immediately transmitted (step 910) as it becomes available. Again, this immediate transmission reduces latency and overhead associated with the encryption process. Encryption and transmission (steps 908, 910) may therefore process concurrently with data receipt (step 902) until all data is received (step 912).

When all data is transmitted, process 900 suitably concludes by transmitting trailer field 806, which suitably contains a CRC or other representation of the data in message 800 that allows the recipient to verify that the data received is complete and accurate. Due to the variable length of payload data 804, trailer 806 may be transmitted after a timeout period (e.g. after no data is received at the clear interface for a period of time), after a maximum amount of data has been transmitted, and/or according to any other criteria. In an exemplary embodiment, each security device 102, 116 supports a configurable maximum payload size (MPS) for the clear interface. Such a parameter may be stored, for example, in the configuration table 220 shown in FIG. 2, and/or may be implemented as an integral part of the communications protocol. Upon receipt of a maximum amount of payload data, the sending security device appropriately formats and sends a trailer including the CRC, with additional SCADA information being transmitted as a payload 804 in a separate message 800.

In various further embodiments, the recipient maintains a “running” CRC of received data that is compared against received data. When a match is found, the recipient knows that the end of payload data 804 is reached and trailer field 806 has begun. In such embodiments, the transmitting device may verify that the CRC bit sequence does not naturally appear in the data stream, which could result in a false understanding by the receiver that the end of a data packet 800 had been reached. In such cases the data packet may be prematurely terminated (e.g. a trailer 806 transmitted), with the additional data being sent in a follow-up packet 800. The transmitting and/or receiving devices may also check for null packets or other undesirable events that may occur during transmission.

With final reference now to FIG. 1, a new system 100 securely transmits SCADA information and other data between a SCADA host 104 and any number of remote terminal units 118A-E using security modules 102, 116A-E. Each security module 102, 116A-E is logically positioned between the communicating device and a transceiver to allow information to be encapsulated within a secure data framework. Because security is maintained by separate modules, the underlying SCADA information and devices need not be modified, thereby allowing implementation across a wide array of new and legacy systems 100.

While at least one exemplary embodiment has been presented in the foregoing detailed description, it should be appreciated that a vast number of variations exist. The various security modules, for example, may be incorporated into SCADA hosts and/or remote terminals, and may be implemented as hardware and/or software “devices” in a wide array of equivalent embodiments. Moreover, the various cryptographic techniques set forth herein could be supplemented, modified or replaced with any other processes or steps. It should also be appreciated that the exemplary embodiments set forth herein are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements and steps described without departing from the scope of the invention as set forth in the appended claims and their legal equivalents.

1. A secure supervisory control and data acquisition (SCADA) system for communicating with a plurality of remote terminal units (RTUs), the secure SCADA system comprising:
a SCADA control host configured to process SCADA information;
a transceiver configured to transfer the SCADA information between the SCADA control host and at least one of the plurality of remote terminal units; and
a host security device (HSD) operatively coupled between the SCADA control host and the transceiver, wherein the HSD is configured to transparently encrypt and decrypt the SCADA information passing through the HSD to thereby establish secure communications between the SCADA control host and the at least one of the plurality of remote terminal units.

2. The secure SCADA system of claim 1 wherein the at least one of the plurality of RTUs is coupled to a remote security device (RSD), and wherein the RSD is configured to interact with the HSD to thereby implement the secure communications between the HSD and the at least one of the plurality of RTUs.

3. The secure SCADA system of claim 2, wherein the HSD is further configured to authenticate the RSD prior to establishing the secure communications.

4. The secure SCADA system of claim 2, wherein the HSD is further configured to maintain a log of communications with the plurality of RSDs.

5. The secure SCADA system of claim 1 wherein the HSD is further configured to encrypt and decrypt the SCADA information using a cryptography protocol.

6. The secure SCADA system of claim 5 wherein the SCADA information comprises a format independent of the cryptography protocol.

7. The secure SCADA system of claim 5 wherein the cryptography protocol is independent of the SCADA information.

8. The secure SCADA system of claim 2 wherein the HSD is further configured to detect tampering in the RSD.

9. The secure SCADA system of claim 2 wherein the HSD is further configured to detect signal tampering between the HSD and the RSD.

10. The secure SCADA system of claim 2 wherein the HSD is further configured to communicate with the SCADA control host to receive control instructions for the RSD.

11. The secure SCADA system of claim 10 wherein the control instructions comprise an instruction to disable the RSD.

12. The secure SCADA system of claim 10 wherein the control instructions comprise an instruction to reboot the RSD.

13. The secure SCADA system of claim 10 wherein the control instructions comprise an instruction to upgrade software stored within the RSD.

14. The secure SCADA system of claim 10 wherein the control instructions comprise an instruction to query the RSD.

15. A secure supervisory control and data acquisition (SCADA) system comprising:
a plurality of remote terminal units (RTUs) systems, each RTU system comprising an RTU transceiver, an RTU and a remote security device (RSD) coupling the RTU to the RTU transceiver; and
a SCADA control host system comprising a SCADA control host configured to exchange SCADA information with each of the RTUs in a SCADA format, and a host security device (HSD) coupling the SCADA control host to a host transceiver, wherein the host transceiver is configured to establish communications with each of the plurality of RTU transceivers;
wherein the HSD is configured to communicate with the plurality of RSDs to transparently encrypt the SCADA information using a cryptographic protocol that is independent of the SCADA protocol to thereby secure the communications between the HSD and each of the plurality of RSDs.

16. The secure SCADA system of claim 15 wherein the HSD is further configured to authenticate each of the plurality of RSDs prior to establishing secure communications.

17. The secure SCADA system of claim 16 wherein the HSD is further configured to encrypt the SCADA information transmitted with each of the plurality of RSDs using a cryptographic key that is unique to that RSD.

18. The secure SCADA system of claim 15 wherein the HSD further comprises an RSD table, and wherein the HSD is further configured to validate each of the plurality of RSDs with the RSD table.

19. The secure SCADA system of claim 18 wherein the HSD is further configured to automatically discover the presence of each of the plurality of RSDs listed in the RSD table.

20. The secure SCADA system of claim 18 wherein the HSD is further configured to identify RSDs that are not listed in the RSD table.

21. The secure SCADA system of claim 18 wherein the HSD is further configured to track the status and availability of each of the plurality of RSDs in the RSD table.

22. A host security device (HSD) for securing communications between a SCADA control host and a remote security device (RSD) via a transceiver, the host security device comprising:
a clear interface configured to communicate with the SCADA control host to thereby exchange clear data between the HSD and the SCADA control host;
a secure interface configured to communicate with the transceiver to thereby exchange encrypted data between the HSD and the RSD; and
a processing module configured to encrypt the clear data received at the clear interface to thereby create encrypted data for transmission via the secure interface, and to decrypt encrypted data received at the secure interface to thereby extract clear data for transmission via the clear interface.

23. The HSD of claim 22 wherein the processing module is further configured to maintain a data log of communications passing through the HSD.

24. A remote security device for securing communications between a host security device (HSD) and a remote terminal unit (RTU) via a transceiver, the remote security device (RSD) comprising:
a clear interface configured to communicate with the RTU to thereby exchange clear data between the RSD and the RTU;
a secure interface configured to communicate with the transceiver to thereby exchange encrypted data between the RSD and the HSD; and
a processing module configured to encrypt the clear data received at the clear interface to thereby create encrypted data for transmission via the secure interface, and to decrypt encrypted data received at the secure interface to thereby extract clear data for transmission via the clear interface.

25. The remote security device of claim 24 further comprising an interface to a camera, and wherein the camera is configured to obtain video images.

26. The remote security device of claim 25 wherein the RSD further comprises a database configured to store the video images.

27. The remote security device of claim 25 wherein the camera is activated when motion in the vicinity of the RSD is detected.

28. The remote security device of claim 25 wherein the video images are photographic images.

29. The remote security device of claim 25 wherein the video images are motion video sequences.

30. A method of transferring SCADA information from a sender to a receiver, the method comprising the steps of:
receiving the SCADA information from a sender at a clear interface;
encrypting the SCADA information using a cryptographic protocol that is independent of the SCADA information to create an encrypted data stream; and
providing the encrypted data stream to a secure interface for transmission to the receiver.

31. The method of claim 30 further comprising the step of authenticating the receiver prior to the encrypting step.

32. The method of claim 31 wherein the authenticating step comprises:
generating a first nonce;
receiving a second nonce from the receiver;
computing a first hash as a function of the first and second nonces;
receiving a second hash from the receiver;
comparing the first and second hashes to each other; and
accepting authentication if the first and second hashes match, and otherwise denying authentication.

33. The method of claim 32 wherein the first hash is further encrypted as a function of a masterskey shared between the sender and receiver.

34. The method of claim 31 further comprising the step of selecting between a secure mode and a pass-through mode for transferring the SCADA information.

35. The method of claim 34 wherein the selecting step comprises the steps of:
generating a first key exchange message;
transmitting the first key exchange message to the receiver;
receiving a second key exchange message from the receiver;
validating the second key exchange message; and
entering the secure mode with the receiver if the second key exchange message is valid.

36. The method of claim 35 wherein the first and second key exchange messages are generated as a function of a randomly generated nonce and a randomly generated session key.

37. The method of claim 36 wherein the first and second key exchange messages comprise verification information relating to the randomly generated session key.

38. The method of claim 37 wherein the first and second key exchange messages are encrypted with a shared master key.

39. The method of claim 34 further comprising the steps of:
generating a key clear message;
transmitting the key clear message to the receiver;
receiving an acknowledgement from the receiver; and
entering the pass-through mode with the receiver after receiving the acknowledgement.

40. The method of claim 39 wherein the key clear message is generated as a function of a nonce, a shared master key, and a session key.

41. The method of claim 30 further comprising the steps of:
receiving encrypted data from the receiver at the secure interface;
decrypting the encrypted data using the cryptographic protocol to extract received SCADA information; and
providing the received SCADA information to the sender via the clear interface.

42. The method of claim 30 wherein the cryptographic protocol comprises an RC4 cipher.

43. The method of claim 30 wherein the cryptographic protocol comprises a DES cipher.

44. The method of claim 30 wherein the cryptographic protocol comprises an AES cipher.

45. The method of claim 30 further comprising the step of transmitting a header to the receiver prior to the providing step.

46. The method of claim 45 wherein the header is transmitted to the receiver immediately upon initial receipt of the SCADA information.

47. The method of claim 45 wherein the header is transmitted to the receiver prior to the encrypting step.

48. The method of claim 46 wherein the encrypting and providing steps take place substantially simultaneously.

49. The method of claim 48 further comprising the step of terminating the encrypting step in response to temporal constraints.

50. The method of claim 48 further comprising the step of terminating the encrypting step as a function of the size of the SCADA information.

51. The method of claim 48 further comprising the step of transmitting a trailer to the receiver following the encrypted SCADA information.

52. A data structure for storing SCADA information, the data structure comprising:
a header field comprising metadata about the SCADA information and a destination address;
a payload field having a variable length for storing the SCADA information; and
a trailer field comprising a checksum for verifying the contents of the payload field.

53. The data structure of claim 52 wherein the payload field comprises data encrypted in a format that is independent of the format of the SCADA information.

54. A signal modulated on a carrier wave, wherein the signal comprises the data structure of claim 52.

55. A digital storage medium having computer-readable data stored thereon, wherein the computer-readable data is formatted according to the data structure of claim 52.

56. Computerized means for transferring SCADA information from a sender to a receiver, the computerized means comprising:
means for receiving the SCADA information from the sender;
means for encrypting the SCADA information using a cryptographic protocol that is independent of the SCADA information to create an encrypted data stream; and
means for providing the encrypted data stream for transmission to the receiver.
